(19) United States
(12) Patent Application Publication
(10) Pub. No.: US 2003/0120576 A1
(43) Pub. Date: Jun. 26, 2003

(54) Method and apparatus for diversifying investment based on risk tolerance

(76) Inventor: Frank A. Duckworth, Vienna, VA (US)

Correspondence Address: MCDERMOTT WILL & EMERY, 600 13th Street, N.W., Washington, DC, 20005-3096, US

(21) Appl. No.: 10/303,065

(22) Filed: Nov. 25, 2002

Related U.S. Application Data
(60) Provisional application No. 60/341,840, filed on Dec. 21, 2001.

(51) Int. Cl. G06F 17/60

(52) U.S. Cl. 705/36

(57) ABSTRACT

A system and method of asset allocation for optimizing investment determines risk tolerance category of the user based on answers to a risk tolerance questionnaire. A value is calculated based on the way the questions are answered and various points assigned to each answer. The calculated value, which correlates to a standard deviation range, and a risk type for that specific value is assigned to the user. According to a predetermined asset allocation table, different asset classes are determined and along with the standard deviation range are plotted on the efficient frontier. The user selects various risk levels and finds various combinations of asset classes. The precise composition of the asset allocation is determined based on the assigned value, corresponding risk type and related asset classes.

### FIELD OF THE INVENTION

The invention relates generally to the field of investment, and more specifically to determining various combinations of asset classes based on the user risk tolerance range.

### BACKGROUND OF INVENTION

Most investors are aware of the benefits associated with investment in a wide range of assets including a mix of asset types in their portfolios. However, a large number of investors who diversify are unable to explain the need for their investment mix and why each type of assets was picked. Some investors, through luck or some gained wisdom, may have been successful in their ad hoc random investments some of the times but the overall performance has been likely far less than desirable. The overall performance could have probably been better with the same risk level that the investor is willing to accept; i.e. a higher return investment could have been made at the same level of risk or even a lower level of risk. One common focus of all investments is to find a particular mix of different assets or diversification that shapes an optimal portfolio, not to select one asset over the others.

Every investor is aware of the risk-return tradeoff, whereby the investor accepts a greater level of risk for obtaining greater returns on investments. In other words, it is generally believed that no greater return is possible without taking extra risk. Return is generally measured as the average annual and continuous rate at which the investment gains value whereas the variance or standard deviation from the average represents the risk associated with that particular return.

The most optimal or efficient portfolio is such that no portfolio having the same standard deviation or risk has a greater return and no portfolio can be found that has the same rate of return with a smaller standard deviation. Based of Modern Portfolio Theory, the locus of all the points representing all efficient portfolios is the efficient frontier. Referring to FIG. 1, the efficient frontier is shown as the curved line below which all the possible investments fall in the shaded area according to their risk and return values. The vertical axis represents investment return and the horizontal axis represents risk or standard deviation from the expected return. Therefore, the lower left part of the frontier represents less risky or conservative investments that have relatively low returns where the right side of the frontier relates to higher risk and return investments. Optimal investments are closer to or on the efficient frontier and represent the highest level of return for a specific level of risk or the lowest risk level for any given level of return. For example, investment in asset A, having a specific risk and return, may be optimized or made more efficient by investing in asset B which has the same level of risk as A but higher return. Similarly, asset C may be picked as it provides the same return as A at a lower level of risk.

For any given portfolio, with any level of risk and return, increasing the number of assets can somewhat reduce the overall risk or standard deviation. This concept gives rise to the need for diversification or combining different assets within a group of unrelated assets, which do not exhibit similar characteristics and have a correlation of zero, with the same risk and return. However, mere diversification of assets may only reduce risk but does not take into account the optimal return and the specific risk level that matches the goals of an investor.

Therefore, determination of investment in various asset classes as well as the precise composition of the asset allocation according to a level of risk determined by the investor is needed.

### DISCLOSURE OF INVENTION

The present invention provides a system that analyzes and determines risk aversion of a user for selecting combinations of asset classes.

Another aspect of the present invention is based on a method of determining risk aversion of a user based on a series of questions and assigning a value that is correlated with a standard deviation range. The method further identifies various risk levels and combinations of asset classes for selection by the user.

Another aspect of the present invention provides for a questionnaire that determines risk tolerance of a user, assigns different points to the answers to the questions and tallies the points according to different weights given to the questions for determining a value assigned to that user. The result is correlated with specific ranges of standard deviation.

According to another aspect of the disclosed invention, the correlated standard deviation ranges are assigned a specific risk type which determines the particular combination of assets and the portion of the portfolio that should consist of each asset class. The standard deviation range and the asset classes are plotted on the efficient frontier for the user to select various risk levels and combinations of asset classes.

A further aspect of the present invention provides software configured to determine risk aversion of a user based on a series of questions and assigning a value to be correlated with a standard deviation range. The software in return provides for a questionnaire that determines risk tolerance of a user, assigns different points to the answers to the questions and tallies the points according to different weights given to the question for determining a value assigned to that user. The result is correlated with specific ranges of standard deviation and identifies various risk levels and combination of asset classes for selection by the user. The software includes databases, control commands for plotting the standard deviation range and specific conditions for determining the precise composition of the asset allocation.

Yet another aspect of the present invention provides a computer-implemented asset allocation system where, according to answers by a user to at least one question and a calculated value based on the answers, a risk type is assigned to the user. The risk type is further correlated to a specific asset allocation plan including at least one asset group. The composition of asset classes for each asset group is then determined by optimizing return for a specific level of risk.

A further aspect of the present invention provides various user interfaces that graphically capture and represent answers to a questionnaire according to user input related to questions that will determine the risk aversion of the user. A user interface graphically displays input frames for entering the answers and assigning values corresponding to risk types that are correlated to a standard deviation range. There is also displayed a graphical representation of the standard deviation ranges plotted on the efficient frontier. Additionally, information related to various risk levels and combinations of asset classes as well as the precise composition of the asset allocation is graphically displayed for the user.

In still another aspect of the present invention, a machine-readable data storage medium encoded with a set of machine-executable instructions for using a data processing system to perform a method of asset allocation is provided. The method comprises the steps of determining a level of risk for a user based on answers provided to a risk tolerance questionnaire, calculating a value based on the answers and assigning the calculated value to the user. The method further includes assigning a risk type to the user based on the calculated value, correlating the risk type to a specific asset allocation that includes at least one asset group and determining a composition of asset classes in each asset group based on the risk type and an optimized return for a specific level of risk.

A further aspect of the invention relates to a unique software. A software product, in accord with this aspect, includes at least one machine-readable medium and programming code, carried by the medium. A computer readable medium, as used herein, may be any physical element or carrier wave, which can bear instructions or code for performing a sequence of steps in a machine-readable form. Computer-readable mediums include, but are not limited to, nonvolatile media such as optical or magnetic disks, volatile media such as dynamic memory, and transmission media such as coaxial cables, copper wire and fiber optics. Transmission media may comprise acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASHEPROM, any other memory chip or cartridge, as well as media bearing the software in a scannable format, a carrier wave as described hereinafter, or any other medium from which a computer can read. A carrier wave medium is any type of signal that may carry digital information representative of the instructions or code for performing the sequence of steps. Such a carrier wave may be received via a wireline or fiber-optic network, via a modem, or as a radio-frequency or infrared signal, or any other type of signal which a computer or the like may receive and decode.

### BRIEF DESCRIPTION OF THE DRAWINGS

The present invention is depicted by way of example, and not by way of limitation, in the following figures.

FIG. 1 shows the efficient frontier and risk/return correlation of an exemplary asset.

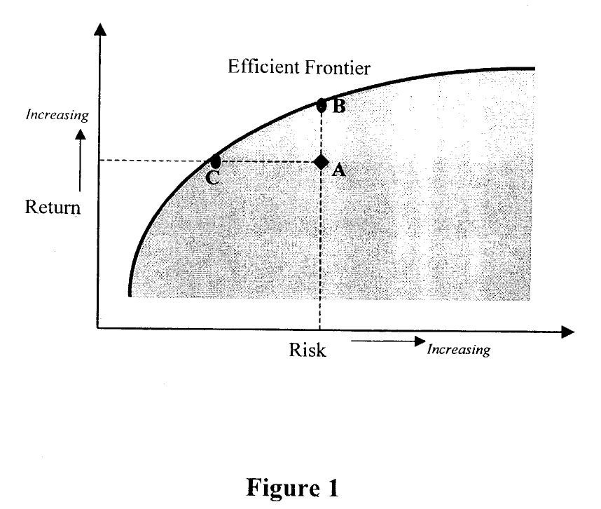

FIG. 2 shows flow diagram of the method of optimized asset allocation according to the risk tolerance of the user.

FIG. 3 shows a table containing examples of the questions and answers used for determining the risk tolerance of the user.

FIGS. 4A and 4B show a table used to assign a range of standard deviation and risk type to a user and a table for correlating risk type with composition of asset classes, respectively.

FIG. 5 shows risk levels and asset classes plotted on the efficient frontier.

FIG. 6 shows a table of asset optimization with the dollar amount change for each asset class.

FIG. 7 shows a computer system configured for performing the steps of investment optimization method in accordance with the invention.

### DETAILED DESCRIPTION OF THE PREFERRED EMBODIMENT OF THE INVENTION

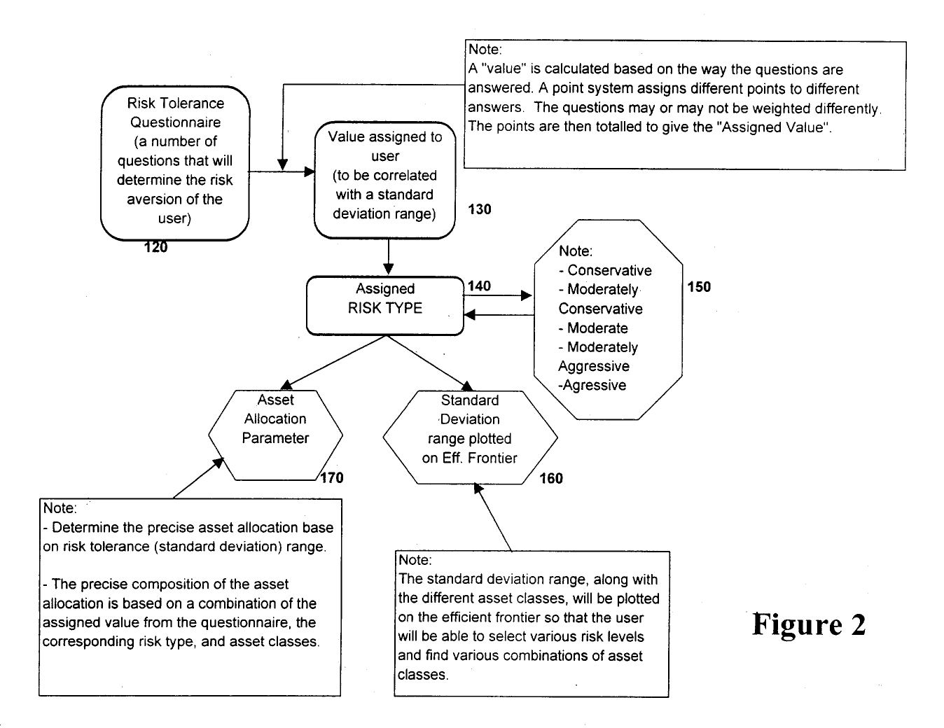

The system and method for diversifying investment having optimized asset allocation will be described in reference to FIG. 2 which depicts a flow diagram for determining the composition of asset allocation. A series of questions in the form of a risk tolerance questionnaire are presented in step 120 to be answered according to the investment preferences and personal profile of a user. The questions determine the risk aversion of the user by obtaining information related to life style, career situation, investment goals and personal data. Some questions relate to gender, income and age, which are factual and other questions are subjective and define investing preferences such as cash margins needed for regular expenditure, income or growth expectations and tolerance for potential investment downturns.

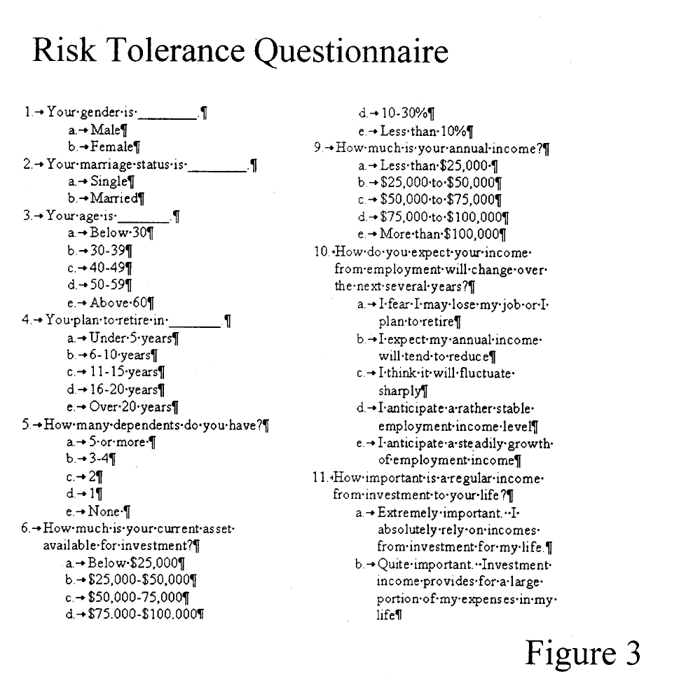

FIG. 3 shows a sample questionnaire for determining investor's risk tolerance in which a point system assigns different points to different answers and each answer gains a specific number of points corresponding to different levels of risk. Based on the sum of the points gained by each answer, a total score is calculated either by straight summation of the points or by weighted scores according to the level of impact each question may have on risk tolerance. For example, the number of dependents may not be weighted as much as the importance of the requirement for investment income. A value, in the form of a straight total score of the answer points or the sum of weighted points for different questions, is generated and assigned to the user.

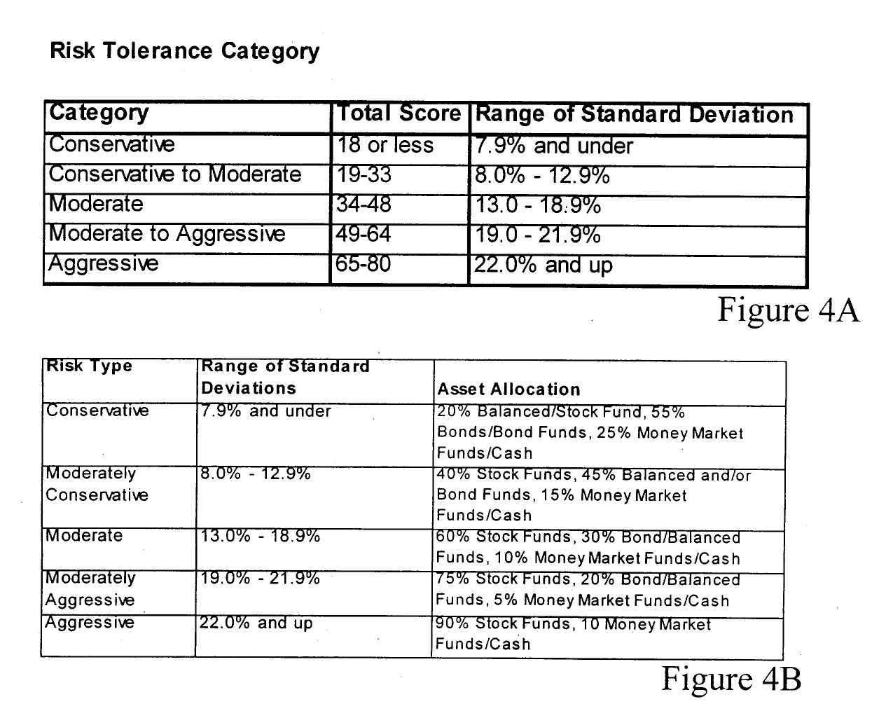

Each value is correlated with a specific standard deviation range or risk range, as shown as step 130 and various risk types are assigned to each value in step 140. The breakdown of various risk types provide categories for a wide range of investors from conservative to aggressive, as shown in section 150 of FIG. 2, which correspond to low to high ranges of standard deviation or risk. FIG. 4A shows an exemplary table in which risk tolerance categories and the range of standard deviation for each corresponding value based on total score are included. FIG. 4B shows another table used for correlating the risk type or category with asset allocation schemes that includes different mixes of investments such as stock funds, bonds and cash, for example. For each group, the overall investment risk corresponds to each risk type although each asset class may have a risk higher or lower in the hierarchy. The mix of asset groups may vary according to economical environment and are updated periodically.

Referring back to FIG. 2, the proper mix of asset classes and the precise composition of each class is obtained in steps 160 and 170. More specifically, the standard deviation ranges that were obtained from the table in FIG. 4A in step 130, along with the different asset classes, obtained from the table in FIG. 4B, are plotted on the efficient frontier. From the plotted standard deviation ranges and asset classes, the user will be able to select various risk levels and find different combinations of asset classes. For each asset class, the precise composition of the asset allocation is determined based on an algorithm that takes into account the assigned value from the questionnaire, the corresponding risk type and asset classes.

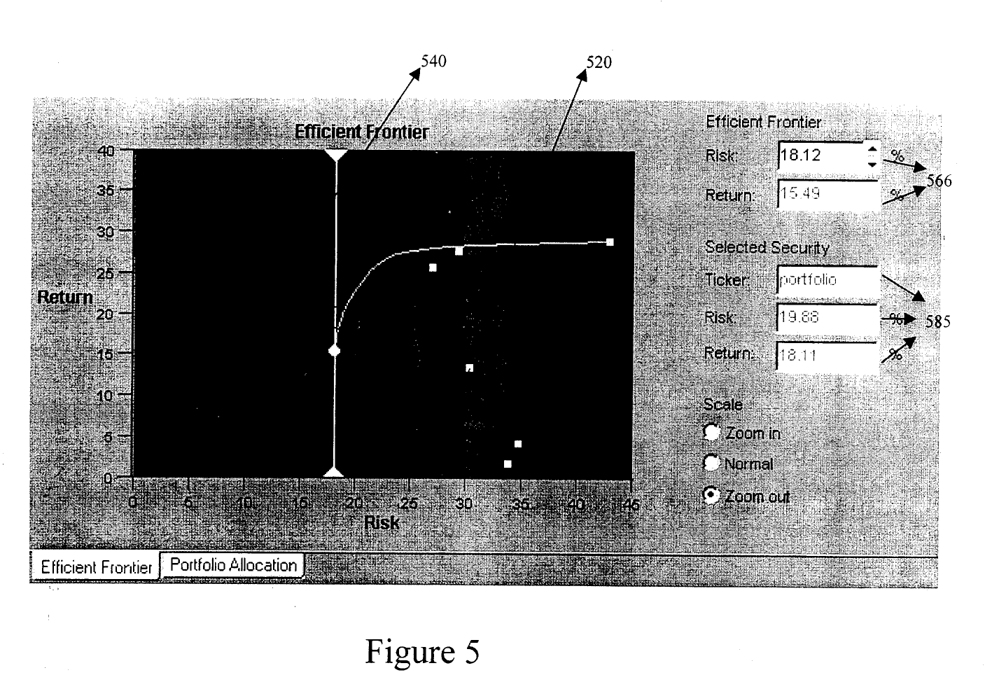

The asset classes and the range of standard deviation or risk are plotted on the efficient frontier, as shown in FIG. 5. Line 520 is the efficient frontier that corresponds to optimal return for any specific investment risk. Line 540 represents a moveable slide that may be moved along the horizontal axis by the user to a point within the risk tolerance range between the points 560 and cross the efficient frontier defining points having optimal returns for a specific risk. Points 560 represent limits of the risk range identified by the investor's risk tolerance questionnaire. The user can slide line 540 along the efficient frontier and adjust it within the “Risk Range” that was identified by the results of the risk tolerance questionnaire. In other words, any point on the efficient frontier crossed by line 540 is the optimized investment for the risk tolerance of the user. Each of the points similar to squares 580 represent an asset class (i.e. large cap value, stocks, mutual funds, etc.) that is included in the asset groups determined by asset allocation. Additional numerical information is provided in Boxes 565 that show the risk and return data related to the overall portfolio according to a level of risk selected or entered by the user in the risk box. Additionally, risk and return data for each asset class may be selected and entered by the user in boxes 585 that show the information for that particular asset class. The graphical interface exemplified in FIG. 5 uses the efficient frontier for identifying various risk levels and selecting various combinations of asset classes.

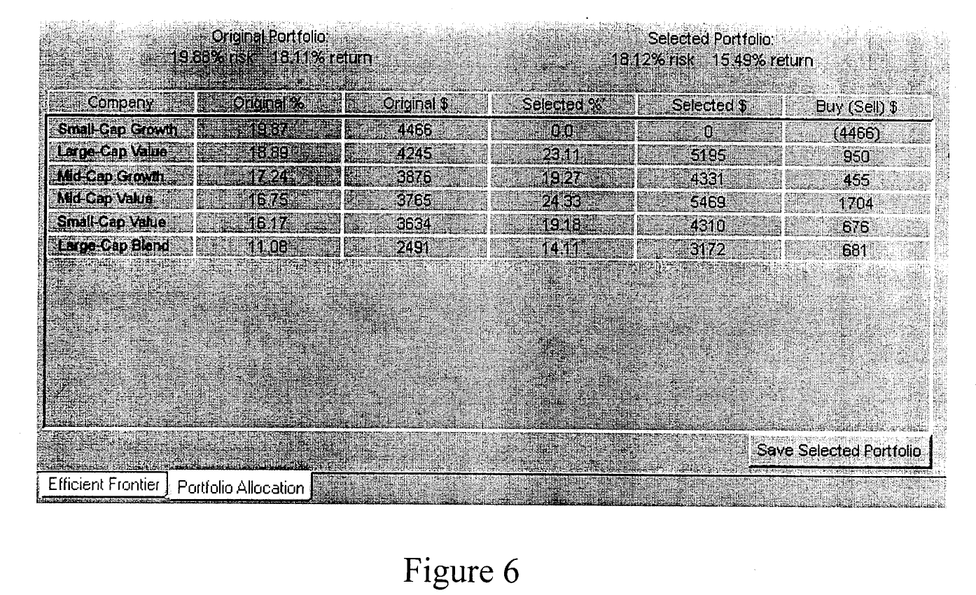

We now refer to FIG. 6 to show a table for the optimized asset allocation by determining the precise composition of asset classes. This table shows the percentage and dollar amount of each asset class the user should hold to reach an optimized return or the highest level of return for the selected level of risk. Optimization is done for each asset class by comparing percentage and dollar amount distribution in the original portfolio with those of the selected portfolio as determined by plotting different asset classes on the efficient frontier. The differences are shown as buy(sell) amounts that indicate the dollar amount of each asset class the user should buy or sell in order to position the portfolio in such a way that the optimized asset allocation is achieved. The user would then save this portfolio and proceed to additional analysis tools.

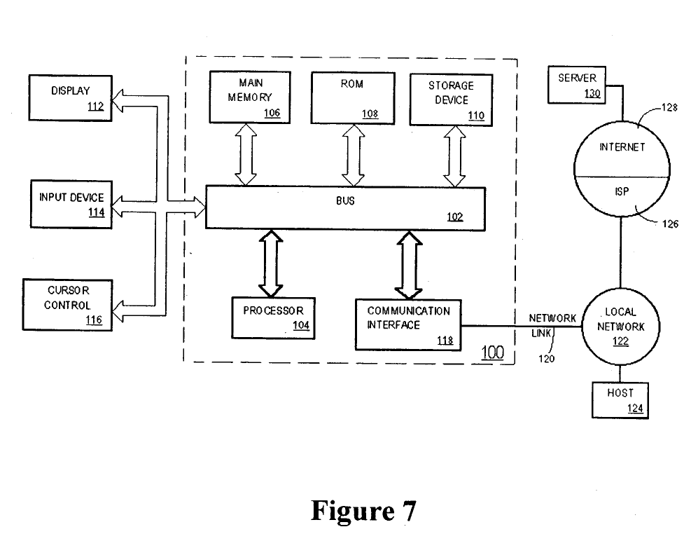

At least portions of the invention are intended to be implemented on or over a network such as the Internet. An example of such a network is described in FIG. 7 showing a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. Other output devices such as printers may be used for providing information to the user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables; copper wire and fiber optics, including the wires that comprise bus 102. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punchcards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infrared transmitter to convert the data to an infrared signal. An infrared detector can receive the data carried in the infrared signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. Processor 104 may execute the received code as it is received, and/or stored in storage device 110, or other non-volatile storage for later execution. In this manner, computer system 100 may obtain application code in the form of a carrier wave.

Although the present invention has been described and illustrated in detail, it is clearly understood that the same is by way of illustration and example only and is not to be taken by way of limitation. One skilled in the art could also vary the design of the features described using known elements to accomplish what is described in this disclosure without departing from the principals that are described.

What is claimed is:

1. A computer-implemented asset allocation system for optimizing investment, comprising:
a risk tolerance questionnaire containing at least one question that determines a level of risk a user accepts based on answers provided to the questionnaire; and
a processor configured for calculating a value based on the answers and assigning the calculated value to the user;
assigning a risk type to the user based on the calculated value;
correlating the risk type to a specific asset allocation plan that includes at least one asset group;
determining a composition of asset classes, that has optimized return for a specific level of risk; and
identifying changes to an original portfolio according to the determined composition.

2. A computer-implemented asset allocation system for optimizing investment, comprising:
at least one question that determines a level of risk a user accepts; and
a processor configured for identifying a level of risk tolerance based on answers to at least one question by a user; and
determining a composition of asset classes, that has optimized return for a specific level of risk based on a risk type obtained from the level of risk tolerance; and
identifying changes to an original portfolio according to the determined composition.

3. A machine-readable data storage medium encoded with a set of machine-executable instructions for using a data processing system to perform a method of asset allocation for optimizing investment, said method comprising the steps of:
determining a level of risk for a user based on answers provided to a risk tolerance questionnaire containing at least one question;
calculating a value based on the answers and assigning the calculated value to the user;
assigning a risk type to the user based on the calculated value;
determining an asset allocation plan including at least one asset group and a composition of asset classes in each asset group based on the risk type and optimized return for a specific level of risk.

4. A computer-implemented method of asset allocation for optimizing investment, said method comprising the steps of:
determining a level of risk for a user based on answers provided to a risk tolerance questionnaire containing at least one question;
calculating a value based on the answers and assigning the calculated value to the user;
assigning a risk type to the user based on the calculated value;
correlating the risk type to a specific asset allocation plan that includes at least one asset group;
determining a composition of asset classes in each asset group based on the risk type and an optimized return for a specific level of risk.

5. A computer-implemented method of asset allocation for optimizing investment as in claim 1, wherein the step of calculating the value further comprises:
assigning points to each answer;
providing a weighted factor to each question; and
determining a value based on the summation of the weighted points.

6. A computer system comprising:
at least one source that provides risk tolerance data;
a processor that receives and processes risk tolerance data to determine a value, a risk type and a corresponding asset allocation plan according to a software algorithm and at least one predetermined table; and
at least one user interface that provides interactive graphics for determining optimized combination of asset classes for asset allocation,
whereby a composition of the asset allocation plan is determined based on the risk tolerance data and asset classes.

7. An asset allocation computer system implemented over a network for optimizing investment comprising:
a network;
at least one user interface connected to said network;
a risk tolerance questionnaire that determines a level of risk a user accepts based on answers provided to the questionnaire containing at least one question; and
at least one processor connected to said network that calculates a value based on the answers and assigns the calculated value to the user according to at least one predetermined table, correlates the risk type to a specific asset allocation plan that includes at least one asset group, determines a composition of asset classes for an optimized return for a specific level of risk and identifies changes to an original portfolio according to the determined composition.

8. Computer-readable instructions for delivering instructional information embodied in a carrier wave, comprising the steps of:
determining a level of risk for a user based on answers provided to a risk tolerance questionnaire;
calculating a value based on the answers and assigning the calculated value to the user;
assigning a risk type to the user based on the calculated value;
correlating the risk type to a specific asset allocation plan that includes at least one asset group;
determining a composition of asset classes in each asset group based on the risk type and an optimized return for a specific level of risk.
